(19) United States
(12) Patent Application Publication
(10) Pub. No.: US 2025/0298831 A1
(43) Pub. Date: Sep. 25, 2025

(54) INFORMATION PROCESSING APPARATUS, INFORMATION PROCESSING METHOD, AND NON-TRANSITORY COMPUTER READABLE STORAGE MEDIUM

(71) Applicant: LY Corporation, Tokyo (JP)

(72) Inventors: Kazuhiro HAYASHI, Tokyo (JP); Yuichiro AMATSU, Tokyo (JP); Seiichi HAGINO, Tokyo (JP); Kaho HIROME, Tokyo (JP); Kazuhiro MINODA, Tokyo (JP); Tomoyo OMURA, Tokyo (JP); Ryota KOBAYASHI, Tokyo (JP); Aya TAKAYANAGI, Tokyo (JP); Kagehiro UENO, Tokyo (JP); Sho SUZUKI, Tokyo (JP); Satoshi HIDA, Tokyo (JP)

(21) Appl. No.: 19/053,272

(22) Filed: Feb. 13, 2025

(30) Foreign Application Priority Data
Mar. 19, 2024 (JP) 2024-044145

(51) Int. Cl. G06F 16/34; G06F 16/215

(52) U.S. Cl. CPC G06F 16/345; G06F 16/215

(57) ABSTRACT

An information processing apparatus according to the present application includes: a selection and rearrangement unit that causes generative AI to execute selection and rearrangement of a plurality of news articles using first instruction information including information indicating an instruction to select the plurality of news articles and information indicating a restriction condition of the selection and second instruction information including information indicating an instruction to rearrange the plurality of news articles and information indicating a restriction condition of the rearrangement; and a summarization unit that causes the generative AI to execute summarization of each of the plurality of news articles using third instruction information including information indicating an instruction to summarize each of the plurality of news articles selected and rearranged by the selection and rearrangement unit.

### CROSS-REFERENCE TO RELATED APPLICATIONS

The present application claims priority to and incorporates by reference the entire contents of Japanese Patent Application No. 2024-044145 filed in Japan on Mar. 19, 2024.

### BACKGROUND OF THE INVENTION

### 1. Field of the Invention

The present invention relates to an information processing apparatus, an information processing method, and a non-transitory computer readable storage medium.

### 2. Description of the Related Art

In recent years, a technique using AI has been proposed. For example, Japanese Laid-open Patent Publication No. 2020-087353 proposes generating a summary of a news article from the news article using a learned neural network model.

However, in a case where there are many news articles, for example, if summaries of all the news articles are generated, processing cost in AI increases, and if all the news articles are collectively summarized, the AI may confuse information.

Thus, there is a problem that it is difficult to effectively provide summaries of news articles.

### SUMMARY OF THE INVENTION

An information processing apparatus according to the present application includes: a selection and rearrangement unit that causes generative AI to execute selection and rearrangement of a plurality of news articles using first instruction information including information indicating an instruction to select the plurality of news articles and information indicating a restriction condition of the selection and second instruction information including information indicating an instruction to rearrange the plurality of news articles and information indicating a restriction condition of the rearrangement; and a summarization unit that causes the generative AI to execute summarization of each of the plurality of news articles using third instruction information including information indicating an instruction to summarize each of the plurality of news articles selected and rearranged by the selection and rearrangement unit.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a view illustrating an example of information processing according to an embodiment;

FIG. 2 is a view illustrating an example of a configuration of an information processing system according to the embodiment;

FIG. 3 is a view illustrating an example of a configuration of an information processing apparatus according to the embodiment;

FIG. 4 is a view illustrating an example of a news article group information table stored in a news article group information storage unit of the information processing apparatus according to the embodiment;

FIG. 5 is a view illustrating an example of a summary information table stored in a summary information storage unit of the information processing apparatus according to the embodiment;

FIG. 6 is a view illustrating an example of a configuration of a deletion target detection unit of a preprocessing unit in a processing unit of the information processing apparatus according to the embodiment;

FIG. 7 is a view illustrating an example of an application screen distributed by a distribution unit in the processing unit of the information processing apparatus according to the embodiment and displayed on a terminal apparatus;

FIG. 8 is a flowchart indicating an example of information processing by the processing unit of the information processing apparatus according to the embodiment; and

FIG. 9 is a hardware configuration diagram illustrating an example of a computer that implements functions of the information processing apparatus according to the embodiment.

### DETAILED DESCRIPTION OF THE PREFERRED EMBODIMENTS

Hereinafter, a mode (hereinafter, referred to as an “embodiment”) for implementing an information processing apparatus, an information processing method, and an information processing program according to the present application will be described in detail with reference to the drawings. Note that the information processing apparatus, the information processing method, and the information processing program according to the present application are not limited by the embodiment. In addition, each embodiment can be appropriately combined within a range in which the processing content does not contradict each other. Further, in the following embodiment, the same parts are denoted by the same reference numerals, and redundant description will be omitted.

### [1. Example of Information Processing]

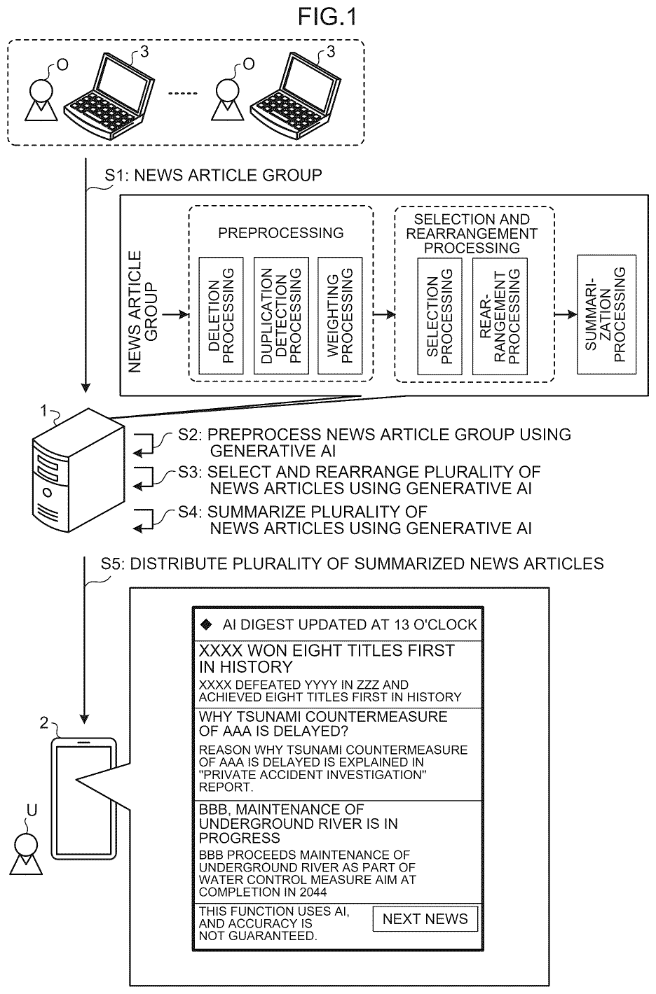

First, an example of information processing according to an embodiment will be described with reference to FIG. 1. FIG. 1 is a view illustrating an example of the information processing according to the embodiment.

As illustrated in FIG. 1, an information processing apparatus 1 receives submission of a plurality of news articles from a plurality of submitter terminals 3 (Step S1). The plurality of submitter terminals 3 are terminals of different submitters. The submitter is, for example, an employee of a news organization, a journalist, or the like, but is not limited to such an example.

Furthermore, the news article submitted by the submitter includes information such as a title, a body, a body snippet, an image, a category, submission date and time (or creation date and time), a keyword, a submitter, and a link to a related article, but is not limited to such an example. The body snippet is a snippet of the body of the news article.

Subsequently, the information processing apparatus 1 performs, using generative artificial intelligence (AI), preprocessing on a news article group including a plurality of news articles submitted in Step S1 (Step S2). The information of the news article group to be used in the preprocessing is indicated by a news article list that is a list of combinations of titles, body snippets, and categories of the news articles included in the news article group, but is not limited to such an example. In the preprocessing using the generative AI, the news article group is indicated in a JavaScript (registered trademark) object notation (JSON) format, but the format is not limited to such an example.

The generative AI is text generative AI, and the text generative AI is, for example, a large-scale language model learned to estimate and output a next token from an input token string, and is, for example, a transformer-based model, a recurrent neural network (RNN)-based model, or the like, but may be a mixed model thereof.

The transformer-based model is, for example, generative pre-trained transformer (GPT) (registered trademark), pathways language model version 2 (PaLM2), large language model meta AI (LLaMA), or the like, but is not limited to such an example. The RNN-based model is, for example, a reception weighted key value (RWKV), or the like, but is not limited to such an example.

Note that the generative AI is desirably learned so as not to include personal information, or the like, in the generation result. The generative AI is arranged in an external information processing apparatus, and the information processing apparatus 1 uses the generative AI via an application programming interface (API), but the generative AI may be arranged in the information processing apparatus 1.

The preprocessing in Step S2 includes, for example, duplication detection processing, deletion target detection processing, and weighting processing. First, deletion processing will be described. The deletion processing is processing of deleting a specific news article in the news article group using the generative AI.

The duplication detection processing will be described. The duplication detection processing is processing of detecting duplication of news articles in the news article group using the generative AI. The information processing apparatus 1 inputs information including instruction information including information indicating an instruction to detect duplication of news articles in the news article group and information of the news article group to the generative AI as a prompt which is input information, and causes the generative AI to detect duplication of news articles.

The instruction information includes information indicating an instruction to output a summary of a topic from a news article and a news article set associated with the summary. For example, the instruction information includes information of a character string “You are an excellent assistant in a role of detecting duplication of the news articles included in a given news article group. Please detect duplication of the news articles according to the following work content. \n\n# Work content \n From the top of the news article group, extract the topic of each news article and output the news articles with the same topic according to the following output format”, information of an input format, and information of an output format.

The information of the input format is information of a format of the information of the news article group to be input, and is, for example, information indicated in a JSON format, and is information indicating a format for listing combinations of titles, body snippets, and categories of the news articles included in the information of the news article group, but is not limited to such an example.

The information of the output format is information of a format of the information to be output by the generative AI. The information of the output format is, for example, information indicated in a JSON format, and is information indicating a format for listing combinations of topics of summaries and news article sets, but is not limited to such an example.

The news article set includes two or more news articles having the same summary of the topic as duplicate news articles, and includes one news article as a non-duplicate news article in a case where there is no news article having the same summary of the topic.

As described above, the information processing apparatus 1 causes the generative AI to output the summary of the topic, and can cause the generative AI to accurately detect duplication of the news articles as compared with a case where duplicate news articles are output without outputting the summary of the topic.

Note that, for example, the information processing apparatus 1 can increase detection accuracy of duplication of news articles by including information indicating an instruction to output a reason for duplication detection in the instruction information. Furthermore, the information processing apparatus 1 can also improve detection accuracy, for example, by including information (few-shot information) indicating an input/output example in the instruction information.

The information processing apparatus 1 deletes duplicate news articles from the news article group based on information output from the generative AI. For example, the information processing apparatus 1 selects one news article from a plurality of news articles included in the article set in the summary of each topic according to a predetermined rule or randomly, and deletes the remaining news articles from the news article group.

Furthermore, for example, the information processing apparatus 1 can cause the generative AI to execute processing of selecting one news article from duplicate news articles. In this case, for example, the information processing apparatus 1 inputs, to the generative AI, information including instruction information including information indicating an instruction to output one news article considered to be most appropriate from the duplicate news articles together with the summary of the topic and information that is a list of combinations of the summaries of the topics and the news article sets as the input information. The information processing apparatus 1 deletes the remaining news articles other than the one news article selected by the generative AI among the plurality of news articles included in the article set in the summary of each topic from the news article group.

Next, the deletion target detection processing is processing of detecting a specific news article as a deletion target. The specific news article is a news article having low speediness, a news article of a predetermined exclusion target category, or the like.

The deletion target detection processing includes first detection processing of detecting a news article having low speediness as a first deletion target, and second detection processing of detecting a news article having predetermined content to be excluded as a second deletion target.

In the first detection processing, the news article with low speediness is a news article of a specific category for which speediness is important and is a news article before a threshold time Tth. The news article of the specific category for which speediness is important is, for example, a category in which a degree of decrease in the newness becomes higher as time elapses from occurrence of an event indicated by the news article. In the first detection processing, in a case where there is a plurality of categories for which speediness is important, different values are set as the threshold time Tth for each category for which speediness is important.

In the first detection processing, the information processing apparatus 1 inputs information including instruction information including information indicating an instruction to detect whether or not a news article in the news article group is a news article with low speediness and information of the news article group to the generative AI as a prompt which is input information, and causes the generative AI to detect information indicating whether or not the news article is a news article with low speediness.

The instruction information in the first detection processing includes information indicating an instruction to output a summary of a news article clearly indicating whether or not the news article is a news article with low speediness and information indicating whether or not the news article is a news article with low speediness (for example, true/false information), and information defining content of a news article with low speediness. The information defining the content of the news article with low speediness includes, for example, information indicating a specific category and information indicating the threshold time Tth described above, but is not limited to such an example.

For example, the instruction information in the first detection processing includes information of a character string “You are an excellent assistant in a role of determining whether or not a news article included in a given news article group is a news article with low speediness. As a determination result, output a summary of a news article clearly indicating whether or not the news article is a news article with low speediness and true/false information indicating whether or not the news article is a news article with low speediness. The true/false information is true in a case where the news article is a news article with low speediness, and false otherwise” and information defining the content of a news article with low speediness.

Note that while in the above-described example, the information processing apparatus 1 causes the generative AI to generate whether or not the news article included in the news article group is a news article with low speediness, the information processing apparatus 1 may cause the generative AI to generate whether or not the news article included in the news article group is a news article with high speediness. The news article with high speediness is a news article for which speediness is not low, and in this case, the instruction information includes information defining content of the news article with high speediness.

The prompt in the first detection processing includes information of an input format and information of an output format in addition to the above-described instruction information. The information of the input format in the first detection processing is information of a format of the news article group, for example, information indicated in a JSON format, and is information indicating a format for listing combinations of titles, body snippets, and categories of the news articles included in the news article group, but is not limited to such an example.

The information of the output format in the first detection processing is information of a format of the information to be output by the generative AI. The information of the output format is, for example, information indicated in a JSON format, and is information indicating a format for listing combinations of summaries of news articles and true/false information, but is not limited to such an example.

In the first detection processing, the information processing apparatus 1 causes the generative AI to output a summary of a news article clearly indicating whether or not the news article is a news article with low speediness, and can improve detection accuracy as compared with a case where true/false information is output without outputting such a summary.

Note that the information processing apparatus 1 can also improve detection accuracy by further including, in the instruction information, information indicating an instruction to output a reason as to whether or not the news article is a news article with low speediness, for example. Furthermore, the information processing apparatus 1 can also improve detection accuracy, for example, by including information (few-shot information) indicating an input/output example in the instruction information.

In the first detection processing, the information processing apparatus 1 deletes a news article with low speediness from the news article group based on the information output from the generative AI. For example, the information processing apparatus 1 deletes a news article for which the true/false information is information indicating false (for example, false) from the news article group.

Next, the second detection processing will be described. In the second detection processing, the news article having the predetermined content to be excluded is a news article distributed in a fixed phrase on a regular basis, a news article distributed in a fixed phrase, a news article distributed in a fixed phrase on a regular basis, or the like, and is, for example, a news article with low newness, but is not limited to such an example.

In the second detection processing, the information processing apparatus 1 inputs information including instruction information including information indicating an instruction to detect whether or not the news article in the news article group is a news article having the predetermined content to be excluded and information of the news article group to the generative AI as a prompt which is input information, and causes the generative AI to detect a news article having the predetermined content to be excluded.

The instruction information in the second detection processing includes, for example, information indicating an instruction to output a summary of a news article clearly indicating whether or not the news article is a news article having the predetermined content to be excluded and information indicating whether or not the news article is a news article having the predetermined content to be excluded (for example, true/false information), and information indicating the predetermined content to be excluded.

For example, the instruction information in the second detection processing includes information of a character string “You are an excellent assistant in a role of determining whether or not the news article included in a given news article group is a news article having content to be excluded described below. As a determination result, output a summary of the news article clearly indicating whether or not the news article is a news article having the content to be excluded and true/false information indicating whether or not the news article is a news article having the content to be excluded. The true/false information is true in a case where the news article is a news article having content to be excluded, and false otherwise” and information indicating the content to be excluded.

The prompt in the second detection processing includes information of an input format and information of an output format in addition to the above-described instruction information. The information of the input format in the second detection processing is information of a format of the news article group, for example, information indicated in a JSON format, and is information indicating a format for listing combinations of titles, body snippets, and categories of the news articles included in the news article group, but is not limited to such an example.

The information of the output format in the second detection processing is information of a format of the information to be output by the generative AI. The information of the output format is, for example, information indicated in a JSON format, and is information indicating a format for listing combinations of summaries of news articles and true/false information, but is not limited to such an example.

In the second detection processing, the information processing apparatus 1 causes the generative AI to output a summary of the news article clearly indicating whether or not the news article is the news article having the content to be excluded, and can improve detection accuracy as compared with a case where the true/false information is output without outputting the summary. Note that the information processing apparatus 1 can also improve detection accuracy, for example, by further including, in the instruction information, information indicating an instruction to output a reason as to whether or not a news article is a news article having the content to be excluded.

In the second detection processing, the information processing apparatus 1 deletes the news article having the content to be excluded from the news article group based on the information output from the generative AI. For example, the information processing apparatus 1 deletes a news article for which the true/false information is information indicating false (for example, true) from the news article group.

Next, the weighting processing will be described. The weighting processing is processing of weighting news articles in the news article group obtained by deleting duplication of news articles by the duplication detection processing and deleting a specific news article by the deletion target detection processing.

In the weighting processing, the information processing apparatus 1 inputs, to the generative AI, information including instruction information including information indicating an instruction to weight news articles in the news article group and information of the news article group as a prompt that is input information, and causes the generative AI to weight the news articles in the news article group.

The instruction information in the weighting processing includes information indicating an instruction to output the summary of the news article and the weight of the news article, and information defining the weight of the news article. The information defining the weight of the news article includes, for example, information of a character string “Please give a higher weight to news that directly affects your life”, or the like, but is not limited to such an example, and the information processing apparatus 1 can change the content that should be taken into account in the weighting according to the purpose. Furthermore, the instruction information in the weighting processing may include, for example, information defining the weight of the news article for each category of the news article.

The prompt in the weighting processing includes information of an input format and information of an output format in addition to the above-described instruction information. The information of the input format in the weighting processing is information of a format of the news article group, for example, information indicated in a JSON format, and is information indicating a format for listing combinations of titles, body snippets, and categories of the news articles included in the news article group, but is not limited to such an example.

The information of the output format in the weighting processing is information of a format of the information to be output by the generative AI. The information of the output format is, for example, information indicated in a JSON format and is information indicating a format for listing combinations of summaries and weights of the news articles, but is not limited to such an example.

In the weighting processing, the information processing apparatus 1 causes the generative AI to output the summary of the news article, and can improve detection accuracy as compared with a case where the information indicating the weight is output without outputting the summary. Note that the information processing apparatus 1 can also improve detection accuracy, for example, by further including information indicating an instruction to output a reason of the weight in the instruction information.

For example, in a case of using the generative AI having characteristics that the news article on the head side of the news article group tends to be more easily selected as the news article selected as the news article satisfying a condition defined by the prompt, the weighting processing is performed in order to reduce the characteristics.

In the weighting processing, the information processing apparatus 1 rearranges the news articles in the news article group obtained by deleting the news articles detected in each of the duplication detection processing and the deletion target detection processing, based on the weight information indicating the weight output by the generative AI such that the higher the weight, the higher the position (head side).

In a case where the information of the news article group includes date and time information indicating date and time (for example, submission date and time or creation date and time) of the news article, the information processing apparatus 1 rearranges the news articles in the news article group based on the weight information and the date and time information such that the higher the weight, the higher the position (head side), and in a case of the same weight, the later the date and time, the higher the position (head side).

Note that, in the preprocessing described above, the duplicate news article is deleted in the duplication detection processing, the news article that is the first deletion target is deleted in the first detection processing, and the news article that is the second deletion target is deleted in the second detection processing, but the present invention is not limited to such an example.

For example, after the duplication detection processing, the first detection processing, and the second detection processing end, the information processing apparatus 1 can delete the duplicate news article, the news article that is the first deletion target, and the news article that is the second deletion target based on the duplication detection processing, the first detection processing, and the second detection processing.

Subsequently, the information processing apparatus 1 causes the generative AI to execute selection and rearrangement processing of selecting and rearranging a plurality of news articles from the news article group preprocessed in Step S2 (Step S3). In Step S3, the information processing apparatus 1 causes the generative AI to execute selection and rearrangement of the plurality of news articles using instruction information (an example of first instruction information) including information indicating an instruction to select the plurality of news articles from the news article group and information indicating a restriction condition of the selection and instruction information (an example of second instruction information) including information indicating an instruction to rearrange the plurality of news articles and information indicating a restriction condition of the rearrangement.

The selection and rearrangement processing includes, for example, selection processing of selecting a plurality of news articles from the news article group preprocessed in Step S2, and rearrangement processing of rearranging the plurality of news articles selected in the selection processing.

First, the selection processing will be described. In the selection processing, the information processing apparatus 1 inputs, to the generative AI, information including instruction information (an example of first instruction information) including information indicating an instruction to select a plurality of news articles from the news article group preprocessed in Step S2 and information indicating the restriction condition of the selection, and the news article group preprocessed in Step S2 as a prompt which is input information, and causes the generative AI to output information of a plurality of news articles selected from the news article group.

In a case where the number of selected news articles is 15, the instruction information in the selection processing includes, for example, information of a character string “Select and output 15 news articles that satisfy the following selection criteria” and information indicating the selection criteria as information indicating the restriction condition. The news article satisfying the selection criteria is, for example, an important news article, a news article with a high degree of interest of many people, a news article with a high degree of desire to be conveyed, or the like.

In this case, the information indicating the selection criteria is, for example, information of a character string “Selection criteria \n \n Important news article \n News article with high degree of interest of many people \n News article with high degree of desire to be conveyed”, but is not limited to such an example as long as an important news article, a news article with a high degree of interest of many people, and a news article with a high degree of desire to be conveyed are selected by the generative AI.

Furthermore, the instruction information in the selection processing may include information specifying each of the number of selected important news articles, the number of selected news articles with high degrees of interest of many people, and the number of selected news articles with high degrees of desire to be conveyed.

Furthermore, the information indicating the selection criteria may include, for example, information of a character string “Please give priority to selection of news articles about Japan”, or the like, so that news articles about Japan are prioritized. Note that the information for giving priority to selection of news articles about Japan is not limited to the above-described example.

The prompt in the selection processing includes information of an input format and information of an output format in addition to the above-described instruction information. The information of the input format in the selection processing is information of a format of the news article group, for example, information indicated in a JSON format, and is information indicating a format for listing combinations of titles, body snippets, and categories of the news articles included in the news article group, but is not limited to such an example.

The information of the output format in the selection processing is information of a format of the information to be output by the generative AI. The information of the output format is, for example, information indicated in a JSON format, and is, for example, information indicating a format for listing titles of the selected news article, but is not limited to such an example.

Next, the rearrangement processing will be described. In the rearrangement processing, the information processing apparatus 1 inputs information including instruction information (an example of second instruction information) including information indicating an instruction to rearrange the plurality of news articles selected in the selection processing and information indicating a restriction condition of the rearrangement and the plurality of news articles selected in the selection processing to the generative AI as a prompt that is input information, and outputs the rearrangement information of the plurality of news articles selected in the selection processing from the generative AI.

The instruction information in the rearrangement processing includes, for example, information of a character string “Rearrange a plurality of news articles provided in accordance with the following rearrangement criteria” and information indicating the rearrangement criteria as information indicating the restriction condition of the rearrangement. The information indicating the rearrangement criteria is, for example, information of a character string “Rearrangement Criteria \n\n Arrange the news articles in order of importance along the following editing policy. \n\n The editing policy is based on the following elements, and consider the following additional criteria: \n Speediness, Public Benefit, Reliability, Novelty, Interest, Degree of Recognition\n \n Additional Criteria \n Prioritize news articles in Japan\n Familiar News Priority Articles \n News articles distributed in the past several hours”, but is not limited to such an example.

The prompt in the rearrangement processing includes information of an input format and information of an output format in addition to the above-described instruction information. The information of the input format is information of a format of the news article group, for example, information indicated in a JSON format, and is information indicating a format for listing combinations of titles, body snippets, and categories of the news articles included in the news article group, but is not limited to such an example.

The information of the output format in the rearrangement processing is information of a format of the information to be output by the generative AI. The information of the output format is, for example, information indicated in a JSON format, and is information indicating a format for listing m combinations of titles of the news articles and summaries of the news articles as one set, but is not limited to such an example. m is an integer of 1 or more.

In the rearrangement processing, the information processing apparatus 1 causes the generative AI to output the summaries of the news articles, and can improve rearrangement accuracy as compared with a case where the news articles are rearranged without outputting the summaries. Note that the information processing apparatus 1 can also improve rearrangement accuracy by further including, for example, information indicating an instruction to output a reason for the rearrangement in the instruction information.

Subsequently, the information processing apparatus 1 executes summarization processing for causing the generative AI to execute summarization of each of the plurality of news articles selected and rearranged in Step S3 (Step S4). The summarization processing is processing for causing the generative AI to execute summarization of each of the plurality of news articles rearranged in Step S3 using a prompt including instruction information (an example of third instruction information) including information indicating an instruction to summarize each of the plurality of news articles selected and rearranged in Step S3 and information of the plurality of news articles rearranged in Step S3.

The summary of each of the plurality of news articles rearranged in Step S3 is, for example, a summary of the title and the body snippet of each of the plurality of news articles rearranged in Step S3, but is not limited to such an example.

The instruction information in the summarization processing includes, for example, information of a character string “Summarize the title and the body of each of the plurality of news articles provided”. In addition, the instruction information in the summarization processing includes information of a character string “Please summarize the title and the body of each of the plurality of news articles provided, with reference to the following input/output example” and information indicating the input/output example. The information indicating the input/output example is information using the title and the body snippet of the news article as an input example and the summarized title and body snippet as an output example, and includes information of a plurality of input/output examples.

In addition, the instruction information in the summarization processing may include information defining the number of characters of the summary of the title and information defining the number of characters of the body snippet. For example, the instruction information in the summarization processing includes information of a character string “The summary of the title of the news article should be about 15 characters, and the summary of the body of the news article should be about 30 characters”, but is not limited to such an example.

The prompt in the summarization processing includes information of an input format and information of an output format in addition to the above-described instruction information. The information of the input format in the summarization processing is information of a format of the news article group, for example, information indicated in a JSON format, and is information indicating a format for listing combinations of titles, body snippets, and categories of the news articles included in the news article group, but is not limited to such an example.

For example, the information of the input format may include information of the body of the news article instead of the information of the body snippet of the news article. In this case, the information of the news article included in the prompt in the summarization processing includes the information of the body of the news article instead of the information of the body snippet of the news article.

The information of the output format in the summarization processing is information of a format of the information to be output by the generative AI. The information of the output format is, for example, information indicated in a JSON format, and is, for example, information indicating a format for listing combinations of titles and body snippets of the summarized news articles, but is not limited to such an example.

Subsequently, the information processing apparatus 1 distributes the plurality of news articles summarized in Step S4 (Step S5). For example, in a case where a distribution request is received from a dedicated application installed in the terminal apparatus 2, the information processing apparatus 1 transmits the plurality of news articles summarized in Step S4 to the terminal apparatus 2. The terminal apparatus 2 receives a plurality of news articles transmitted from the information processing apparatus 1, and displays the received plurality of news articles.

In the example illustrated in FIG. 1, the first three news articles among the plurality of news articles summarized in Step S4 are displayed on the terminal apparatus 2. A user of the terminal apparatus 2 can select the “next news” button, and in this case, the terminal apparatus 2 displays three news articles in the next rank.

As described above, the information processing apparatus 1 causes the generative AI to execute selection and rearrangement of the plurality of news articles using the instruction information (an example of the first instruction information) including the information indicating an instruction to select the plurality of news articles and the information indicating the restriction condition of the selection and the instruction information (an example of the second instruction information) including the information indicating an instruction to rearrange the plurality of news articles and the information indicating the restriction condition of the rearrangement, and then causes the generative AI to execute summarization of each of the plurality of news articles using the instruction information (an example of the second instruction information) including the information indicating an instruction to summarize each of the plurality of rearranged news articles.

As a result, the information processing apparatus 1 can appropriately narrow down the news articles to be summarized as compared with a case where all the news articles in the news article group to be distributed are summarized, and can effectively summarize the news articles. Furthermore, the information processing apparatus 1 rearranges the news articles before summarization, so that the information processing apparatus 1 can appropriately summarize the news articles.

Hereinafter, configurations, and the like, of an information processing system including the information processing apparatus 1, the terminal apparatus 2, the submitter terminal 3, and the like, that perform such processing will be described in detail.

### [2. Configuration of Information Processing System]

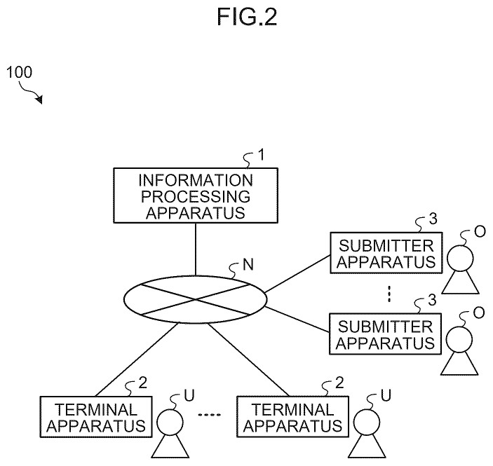

FIG. 2 is a view illustrating an example of a configuration of the information processing system according to the embodiment. As illustrated in FIG. 2, an information processing system 100 according to the embodiment includes the information processing apparatus 1, a plurality of terminal apparatuses 2, and a plurality of submitter terminals 3.

The plurality of terminal apparatuses 2 are used by different users U. The plurality of submitter terminals 3 are used by different submitters. Each terminal apparatus 2 and each submitter terminal 3 are, for example, a notebook personal computer (PC), a desktop PC, a smartphone, a tablet PC, or a wearable device. The wearable device is, for example, a smart glass, a smart watch, or the like, but is not limited to such an example.

The information processing apparatus 1, and each of the terminal apparatuses 2 and the submitter terminals 3 are communicably connected to each other in a wired or wireless manner via a network N. Note that the information processing system 100 illustrated in FIG. 2 may include a plurality of information processing apparatuses 1, and the like.

The network N includes, for example, a wide area network (WAN) such as the Internet and a mobile communication network such as long term evolution (LTE), fourth generation (4G), or fifth generation (5G).

Each terminal apparatus 2 and each submitter terminal 3 can be connected to the network N via short-range wireless communication such as a mobile communication network, Bluetooth (registered trademark), or a wireless local area network (LAN), and can communicate with the information processing apparatus 1.

### [3. Configuration of Information Processing Apparatus 1]

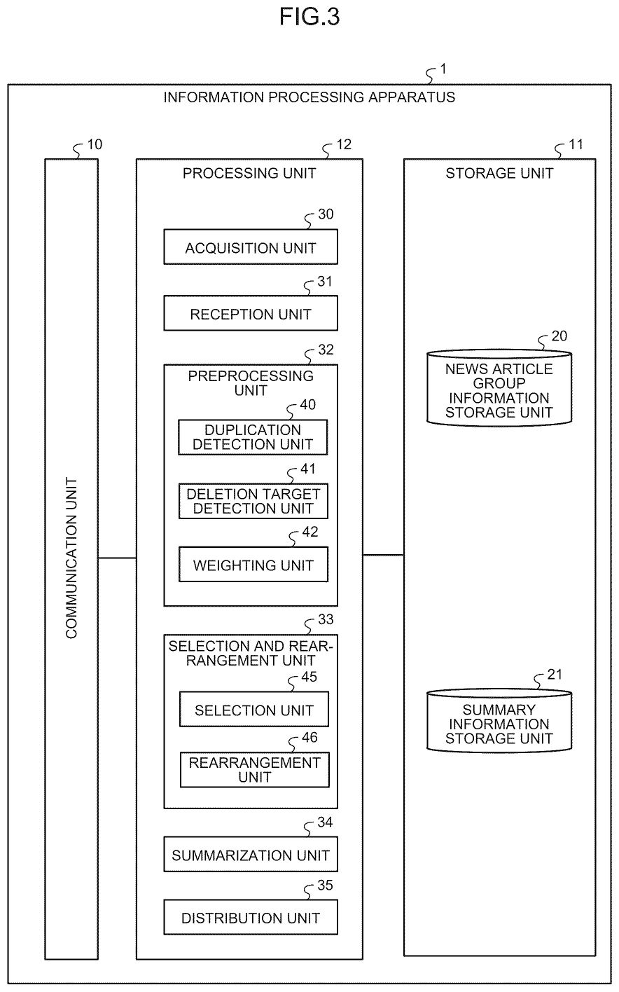

FIG. 3 is a view illustrating an example of a configuration of the information processing apparatus 1 according to the embodiment. As illustrated in FIG. 3, the information processing apparatus 1 includes a communication unit 10, a storage unit 11, and a processing unit 12.

### [3.1. Communication Unit 10]

The communication unit 10 is implemented by, for example, a communication module, a network interface card (NIC), or the like. Further, the communication unit 10 is connected to the network N in a wired or wireless manner, and transmits and receives information to and from various other apparatuses. For example, the communication unit 10 transmits and receives information to and from the terminal apparatus 2 via the network N.

### [3.2. Storage Unit 11]

The storage unit 11 is implemented by, for example, a semiconductor memory element such as a random access memory (RAM) or a flash memory, or a storage apparatus such as a hard disk or an optical disk. The storage unit 11 includes a news article group information storage unit 20 and a summary information storage unit 21.

### [3.2.1. News Article Group Information Storage Unit 20]

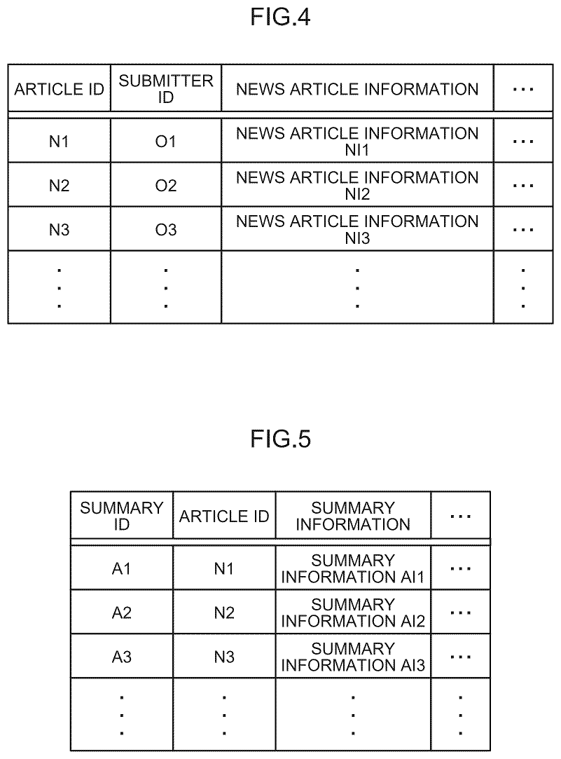

The news article group information storage unit 20 stores various types of information regarding the news articles included in the news article group. FIG. 4 is a view illustrating an example of a news article group information table stored in the news article group information storage unit 20 of the information processing apparatus 1 according to the embodiment.

In the example illustrated in FIG. 4, the news article group information table stored in the news article group information storage unit 20 includes information of items such as “article identifier (ID)”, “submitter ID”, and “news article information”. The “article ID” is an identifier for identifying a news article included in the news article group, and is information attached to each news article.

The “submitter ID” is information of a submitter who has submitted the news article corresponding to the “article ID”. The “news article information” includes information such as a title, a body, a body snippet, an image, a category, submission date and time (or creation date and time), a keyword, a submitter, and a link to a related article of the news article corresponding to the “article ID”, but is not limited to such an example.

### [3.2.2. Summary Information Storage Unit 21]

The summary information storage unit 21 stores various types of information of the news article summarized by the processing unit 12. FIG. 5 is a view illustrating an example of a summary information table stored in the summary information storage unit 21 of the information processing apparatus 1 according to the embodiment.

In the example illustrated in FIG. 5, the summary information table stored in the summary information storage unit 21 includes information of items such as “summary ID”, “article ID”, and “summary information”. The “summary ID” is an identifier for identifying a summary and is information attached to each summary. The “article ID” is an article ID of a news article corresponding to the summary indicated by the “summary ID”.

The “summary information” is information of the summary indicated by the “summary ID”, and includes, for example, information such as a summary of a title of a news article and a summary of a body snippet. Note that the “summary information” may include information indicating the date and time when the summary indicated by the “summary ID” has been created.

### [3.3. Processing Unit 12]

The processing unit 12 is a controller, and is implemented by, for example, a central processing unit (CPU), a micro processing unit (MPU), or the like, executing various programs stored in a storage apparatus inside the information processing apparatus 1 using a RAM as a work area.

Part or the whole of the processing unit 12 may be implemented by, for example, an integrated circuit such as an application specific integrated circuit (ASIC) or a field programmable gate array (FPGA).

As illustrated in FIG. 3, the processing unit 12 includes an acquisition unit 30, a reception unit 31, a preprocessing unit 32, a selection and rearrangement unit 33, a summarization unit 34, and a distribution unit 35, and implements or executes functions and operation of information processing described below. Note that an internal configuration of the processing unit 12 is not limited to the configuration illustrated in FIG. 3, and may be another configuration as long as information processing to be described later is performed.

### [3.3.1. Acquisition Unit 30]

The acquisition unit 30 acquires various types of information from an external information processing apparatus, the terminal apparatus 2, or the like, via the communication unit 10, and causes the storage unit 11 to store the acquired information.

In addition, the acquisition unit 30 acquires various types of information from the storage unit 11. For example, the acquisition unit 30 acquires the information of the news article group from the news article group information storage unit 20, or the like. In addition, the acquisition unit 30 acquires summary information from the summary information storage unit 21, or the like.

[3.3.2. Reception Unit 31]The reception unit 31 receives various requests, information, and the like, from the terminal apparatus 2 and the submitter terminal 3 via the communication unit 10. For example, the reception unit 31 receives a summary distribution request transmitted from the terminal apparatus 2.

Further, the reception unit 31 receives a submission request transmitted from the submitter terminal 3. The submission request includes information such as a news article. In a case where the submission request is received, the reception unit 31 stores information such as a news article included in the submission request in the news article group information storage unit 20.

The news article included in the submission request includes information such as a title, a body, a body snippet, an image, a category, submission date and time (or creation date and time), a keyword, a submitter, and a link to a related article of the news article, but is not limited to such an example.

### [3.3.3. Preprocessing Unit 32]

The preprocessing unit 32 performs, using the generative AI, preprocessing on the news article group acquired by the acquisition unit 30. For example, the preprocessing unit 32 performs, using the generative AI, preprocessing on the news article group from which a plurality of news articles is to be selected by the selection and rearrangement unit 33.

The information of the news article group to be used in the preprocessing is indicated by a news article list that is a list of combinations of titles, body snippets, and categories of the news articles included in the news article group, but is not limited to such an example. The news article group is indicated in a JSON format, but is not limited to such an example.

The generative AI is text generative AI, and the text generative AI is, for example, a large-scale language model learned to estimate and output a next token from an input token string, and is, for example, a transformer-based model, an RNN-based model, or the like, but may be a mixed model thereof.

The transformer-based model is, for example, GPT, PaLM2, LLaMA, or the like, but is not limited to such examples. The RNN-based model is, for example, RWKV, or the like, but is not limited to such an example. Note that the generative AI is desirably learned so as not to include personal information, or the like, in the generation result. The generative AI is arranged in an external information processing apparatus, and the information processing apparatus 1 uses the generative AI via an API, but the generative AI may be arranged in the information processing apparatus 1.

The preprocessing unit 32 includes a duplication detection unit 40 that detects duplication of news articles in the news article group, a deletion target detection unit 41 that detects a news article to be deleted in the news article group, and a weighting unit 42 that weights the news articles in the news article group. Hereinafter, the duplication detection unit 40, the deletion target detection unit 41, and the weighting unit 42 will be described in this order.

### [3.3.3.1. Duplication Detection Unit 40]

The duplication detection unit 40 detects, using the generative AI, duplication of news articles in the news article group. For example, the duplication detection unit 40 performs, using the generative AI, processing of detecting duplication of news articles with use of instruction information including an instruction to detect duplication of news articles in the news article group.

For example, the duplication detection unit 40 inputs information including instruction information including information indicating an instruction to detect duplication of news articles in the news article group and information including information of the news article group to the generative AI as a prompt which is input information, and causes the generative AI to detect duplication of news articles.

The instruction information includes information indicating an instruction to output a summary of a topic from a news article and a news article set associated with the summary. For example, the instruction information includes information of a character string “You are an excellent assistant in a role of detecting duplication of the news articles included in a given news article group. Please detect duplication of the news articles according to the following work content. \n\n# Work content \n From the top of the news article group, extract the topic of each news article and output the news articles with the same topic according to the following output format”, information of an input format, and information of an output format.

The information of the input format is information of a format of the information of the news article group to be input, and is, for example, information indicated in a JSON format, and is information indicating a format for listing combinations of titles, body snippets, and categories of the news articles included in the information of the news article group, but is not limited to such an example.

The information of the output format is information of a format of the information to be output by the generative AI. The information of the output format is, for example, information indicated in a JSON format, and is information indicating a format for listing combinations of topics of summaries and news article sets, but is not limited to such an example.

The news article set includes two or more news articles having the same summary of the topic as duplicate news articles, and includes one news article as a non-duplicate news article in a case where there is no news article having the same summary of the topic.

As described above, the duplication detection unit 40 causes the generative AI to output the summary of the topic, and can cause the generative AI to accurately detect duplication of the news articles as compared with a case where the duplicate news articles are output without outputting the summary of the topic.

Note that the duplication detection unit 40 can also improve detection accuracy of duplication of news articles by, for example, including information indicating an instruction to output a reason for the duplication detection in the instruction information. Furthermore, the duplication detection unit 40 can also improve detection accuracy by, for example, including information (few-shot information) indicating an input/output example in the instruction information.

The duplication detection unit 40 deletes the duplicate news articles from the news article group based on the information output from the generative AI. For example, the duplication detection unit 40 selects one news article from a plurality of news articles included in the article set in each summary of the topic according to a predetermined rule or randomly, and deletes the remaining news articles from the news article group.

Furthermore, the duplication detection unit 40 can also cause the generative AI to execute processing of selecting one news article from duplicate news articles, for example. In this case, for example, the duplication detection unit 40 inputs, to the generative AI, information including instruction information including information indicating an instruction to output one news article considered to be most appropriate from the duplicate news articles together with the summary of the topic and information listing combinations of the summaries of the topics and the news article sets as the input information.

The duplication detection unit 40 deletes the remaining news articles other than the one news article selected by the generative AI among the plurality of news articles included in the article set in each summary of the topic from the news article group. Note that the duplication detection unit 40 can also cause the generative AI not to output the summary of the topic.

### [3.3.3.2. Deletion Target Detection Unit 41]

The deletion target detection unit 41 is processing of detecting a specific news article as a deletion target. For example, the deletion target detection unit 41 performs, using the generative AI, processing of detecting a specific news article with use of instruction information including an instruction to detect the specific news article to be deleted in the news article group. The specific news article is a news article that does not require speediness, a news article of a predetermined exclusion target category, or the like.

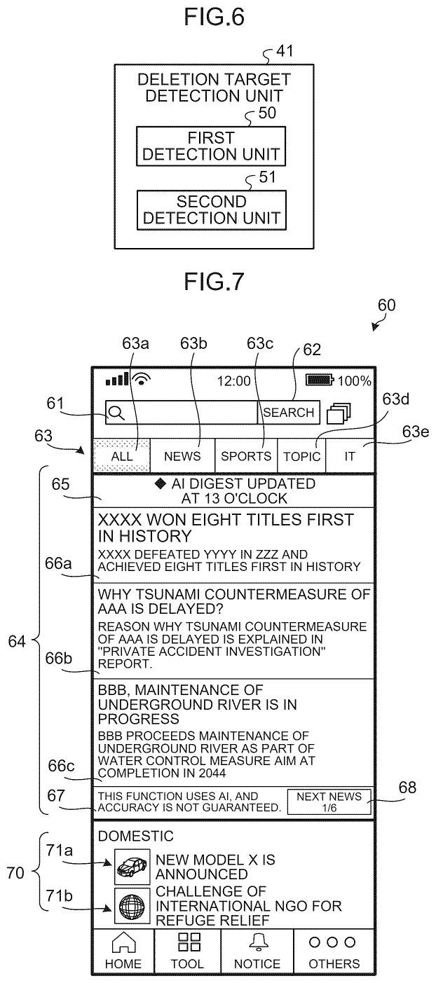

FIG. 6 is a view illustrating an example of a configuration of the deletion target detection unit 41 of the preprocessing unit 32 in the processing unit 12 of the information processing apparatus 1 according to the embodiment. As illustrated in FIG. 6, the deletion target detection unit 41 includes a first detection unit 50 that detects a news article with low speediness as a first deletion target, and second detection processing that detects a news article with predetermined content to be excluded as a second deletion target.

### [3.3.3.2.1. First Detection Unit 50]

The first detection unit 50 detects a news article with low speediness as the first deletion target. The news article with low speediness is a news article of a specific category for which speediness is important and is a news article before a threshold time Tth.

The news article of the specific category for which speediness is important is, for example, a category in which a degree of decrease in the newness becomes higher as time elapses from occurrence of an event indicated by the news article. In the first detection unit 50, in a case where there is a plurality of categories for which speediness is important, different values can be set for the threshold time Tth for each category for which speediness is important.

The first detection unit 50 inputs information including instruction information including information indicating an instruction to detect whether or not a news article in the news article group is a news article with low speediness and information of the news article group to the generative AI as a prompt which is input information, and causes the generative AI to detect information indicating whether or not the news article is a news article with low speediness.

The instruction information includes: information indicating an instruction to output a summary of a news article clearly indicating whether or not the news article is a news article with low speediness and information indicating whether or not the news article is a news article with low speediness (for example, true/false information); and information defining content of a news article with low speediness. The information defining the content of the news article with low speediness includes, for example, information indicating a specific category and information indicating the threshold time Tth described above, but is not limited to such an example.

The instruction information includes, for example, information of a character string “You are an excellent assistant in a role of determining whether or not the news article included in a given news article group is a news article with low speediness. As a determination result, output a summary of the news article clearly indicating whether or not the news article is a news article with low speediness and true/false information indicating whether or not the news article is a news article with low speediness. The true/false information is true in a case where the news article is a news article with low speediness, and false otherwise” and information defining content of the news article with low speediness.

Note that, in the example described above, the first detection unit 50 causes the generative AI to generate whether or not the news article included in the news article group is a news article with low speediness. However, it is also possible to cause the generative AI to generate whether or not the news article included in the news article group is a news article with high speediness. The news article with high speediness is a news article for which speediness is not low, and in this case, the instruction information includes information defining content of the news article with high speediness.

The prompt includes, in addition to the above-described instruction information, information of an input format and information of an output format. The information of the input format is information of a format of the news article group, for example, information indicated in a JSON format, and is information indicating a format for listing combinations of titles, body snippets, and categories of the news articles included in the news article group, but is not limited to such an example.

The information of the output format is information of a format of the information to be output by the generative AI. The information of the output format is, for example, information indicated in a JSON format, and is information indicating a format for listing combinations of summaries of news articles and true/false information, but is not limited to such an example.

The first detection unit 50 causes the generative AI to output a summary of a news article clearly indicating whether or not the news article is a news article with low speediness, and can improve detection accuracy as compared with a case where true/false information is output without outputting such a summary.

Note that the first detection unit 50 can also improve detection accuracy, for example, by further including, in the instruction information, information indicating an instruction to output a reason as to whether or not the news article is a news article with low speediness. Furthermore, the first detection unit 50 can also improve detection accuracy by, for example, including information (few-shot information) indicating an input/output example in the instruction information.

The first detection unit 50 deletes a news article with low speediness from the news article group based on the information output from the generative AI. For example, the first detection unit 50 deletes a news article for which the true/false information is information indicating false (for example, false) from the news article group.

### [3.3.3.2.2. Second Detection Unit 51]

The second detection unit 51 detects a news article having predetermined content to be excluded as the second deletion target. In the second detection unit 51, the news article having the predetermined content to be excluded is, for example, a news article distributed on a regular basis, a news article distributed in a fixed phrase, a news article distributed in a fixed phrase on a regular basis, or the like, and is, for example, a news article with low newness, but is not limited to such an example.

The second detection unit 51 inputs information including instruction information including information indicating an instruction to detect whether or not the news article in the news article group is a news article having the predetermined content to be excluded and information of the news article group to the generative AI as a prompt which is input information, and causes the generative AI to detect a news article having the predetermined content to be excluded.

The instruction information includes, for example, information indicating an instruction to output a summary of a news article clearly indicating whether or not the news article is a news article having the predetermined content to be excluded and information indicating whether or not the news article is a news article having the predetermined content to be excluded (for example, true/false information), and information indicating the predetermined content to be excluded.

The instruction information includes, for example, information of a character string “You are an excellent assistant in a role of determining whether or not the news article included in a given news article group is a news article having the content to be excluded described below. As a determination result, output a summary of the news article clearly indicating whether or not the news article is a news article having the content to be excluded and true/false information indicating whether or not the news article is a news article having the content to be excluded. The true/false information is true in a case where the news article is a news article having the content to be excluded, and false otherwise” and information indicating the content to be excluded.

The prompt includes, in addition to the above-described instruction information, information of an input format and information of an output format. The information of the input format is information of a format of the news article group, for example, information indicated in a JSON format, and is information indicating a format for listing combinations of titles, body snippets, and categories of the news articles included in the news article group, but is not limited to such an example.

The information of the output format is information of a format of the information to be output by the generative AI. The information of the output format is, for example, information indicated in a JSON format, and is information indicating a format for listing combinations of summaries of news articles and true/false information, but is not limited to such an example.

In the second detection processing, the second detection unit 51 causes the generative AI to output a summary of the news article clearly indicating whether or not the news article is the news article having the content to be excluded, and can improve detection accuracy as compared with a case where the true/false information is output without outputting the summary. Note that the second detection unit 51 can also improve detection accuracy, for example, by further including, in the instruction information, information indicating an instruction to output a reason as to whether or not the news article is a news article having the content to be excluded.

In the second detection processing, the second detection unit 51 deletes the news article having the content to be excluded from the news article group based on the information output from the generative AI. For example, the second detection unit 51 deletes a news article for which the true/false information is information indicating false (for example, true) from the news article group.

Note that, in the preprocessing described above, the duplicate news article is deleted in the duplication detection processing by the duplication detection unit 40, the news article that is the first deletion target is deleted in the first detection processing by the first detection unit 50, and the news article that is the second deletion target is deleted in the second detection processing by the second detection unit 51, but the present invention is not limited to such an example. For example, after the duplication detection processing by the duplication detection unit 40, the first detection processing by the first detection unit 50, and the second detection processing by the second detection unit 51 end, the preprocessing unit 32 can delete the duplicate news article, the news article that is the first deletion target, and the news article that is the second deletion target based on the duplication detection processing, the first detection processing, and the second detection processing.

### [3.3.3.3. Weighting Unit 42]

The weighting unit 42 weights news articles in the news article group obtained by deleting duplication of news articles by the duplication detection unit 40 and deleting a specific news article by the deletion target detection unit 41.

For example, the weighting unit 42 weights, using the generative AI, the news articles using the instruction information including the instruction to weight the news articles in the news article group. For example, the weighting unit 42 inputs, to the generative AI, information including instruction information including information indicating an instruction to weight the news articles in the news article group and information of the news article group as a prompt that is input information, and causes the generative AI to weight the news articles in the news article group.

The instruction information includes information indicating an instruction to output a summary of the news article and a weight of the news article, and information defining the weight of the news article. The information defining the weight of the news article includes, for example, information of a character string “Please give a higher weight to news that directly affects your life”, but is not limited to such an example, and the weighting unit 42 can change content that should be taken into account in the weighting according to the purpose. Furthermore, the instruction information may include, for example, information defining the weight of the news article for each category of the news article.

The prompt includes, in addition to the above-described instruction information, information of an input format and information of an output format. The information of the input format is information of a format of the news article group, for example, information indicated in a JSON format, and is information indicating a format for listing combinations of titles, body snippets, and categories of the news articles included in the news article group, but is not limited to such an example.

The information of the output format is information of a format of the information to be output by the generative AI. The information of the output format is, for example, information indicated in a JSON format and is information indicating a format for listing combinations of summaries and weights of the news articles, but is not limited to such an example.

The weighting unit 42 causes the generative AI to output the summary of the news article, and can improve detection accuracy as compared with a case where the information indicating the weight is output without outputting the summary. Note that the weighting unit 42 can also improve detection accuracy, for example, by further including information indicating an instruction to output a reason of the weighting in the instruction information.

For example, in a case of using the generative AI having characteristics that the news article on the head side of the news article group tends to be more easily selected as the news article selected as the news article satisfying a condition defined by the prompt, the weighting unit 42 performs weighting to reduce the characteristics.

After causing the generative AI to output the weights of the news articles in the news article group, the weighting unit 42 rearranges the news articles in the news article group based on the weights. For example, the weighting unit 42 rearranges the news articles in the news article group obtained by deleting the news articles respectively detected by the duplication detection unit 40 and the deletion target detection unit 41 based on the weight information indicating the weights output by the generative AI such that the higher the weight, the higher the position (head side).

In a case where the information of the news article group includes date and time information indicating the date and time (for example, submission date and time or creation date and time) of the news article, the weighting unit 42 rearranges the news articles in the news article group based on the weighting information and the date and time information such that the higher the weight, the higher the position (head side), and in a case of the same weight, the later the date and time, the higher the position (head side).

### [3.3.4. Selection and Rearrangement Unit 33]

The selection and rearrangement unit 33 causes the generative AI to select and rearrange a plurality of news articles from the news article group preprocessed by the preprocessing unit 32. For example, after selecting a plurality of news articles using the generative AI, the selection and rearrangement unit 33 rearranges the plurality of news articles using the generative AI.

The selection and rearrangement unit 33 causes the generative AI to execute selection and rearrangement of a plurality of news articles using, for example, instruction information (an example of first instruction information) including information indicating an instruction to select a plurality of news articles from the news article group and information indicating a restriction condition of the selection and instruction information (an example of second instruction information) including information indicating an instruction to rearrange a plurality of news articles and information indicating a restriction condition of the rearrangement.

The selection and rearrangement unit 33 includes, for example, a selection unit 45 that selects a plurality of news articles from the news article group preprocessed by the preprocessing unit 32, and a rearrangement unit 36 that rearranges the plurality of news articles selected by the selection unit 45.

### [3.3.4.1. Selection Unit 45]

The selection unit 45 inputs information including instruction information (an example of first instruction information) including information indicating an instruction to select a plurality of news articles from the news article group preprocessed by the preprocessing unit 32 and information indicating the restriction condition of the selection and the news article group preprocessed by the preprocessing unit 32 to the generative AI as a prompt which is input information, and outputs information of a plurality of news articles selected from the news article group from the generative AI.

In a case where the number of selected news articles is 15, the instruction information includes, for example, information of a character string “Select and output 15 news articles that satisfy the following selection criteria” and information indicating the selection criteria as the information indicating the restriction condition. The news article satisfying the selection criteria is, for example, an important news article, a news article with a high degree of interest of many people, a news article with a high degree of desire to be conveyed, or the like.

In this case, the information indicating the selection criteria is, for example, information of a character string “Selection criteria \n \n Important news article \n News article with high degree of interest of many people \n News article with high degree of desire to be conveyed”, but is not limited to such an example as long as an important news article, a news article with a high degree of interest of many people, and a news article with a high degree of desire to be conveyed are selected by the generative AI.

Furthermore, the instruction information may include information specifying each of the number of important news articles to be selected, the number of news articles with high degrees of interest of many people, which are to be selected, and the number of news articles with high degrees of desire to be conveyed, which are to be selected.

Furthermore, the information indicating the selection criteria may include, for example, information of a character string “Please give priority to selection of news articles about Japan”, or the like, so that news articles about Japan are prioritized. Note that the information for giving priority to selection of news articles about Japan is not limited to the above-described example.

The prompt includes, in addition to the above-described instruction information, information of an input format and information of an output format. The information of the input format is information of a format of the news article group, for example, information indicated in a JSON format, and is information indicating a format for listing combinations of titles, body snippets, and categories of the news articles included in the news article group, but is not limited to such an example. Note that the information of the input format may include information of the weight given to the news article by the weighting unit 42.

The information of the output format is information of a format of the information to be output by the generative AI. The information of the output format is, for example, information indicated in a JSON format, and is, for example, information indicating a format for listing titles of the selected news article, but is not limited to such an example.

### [3.3.4.2. Rearrangement Unit 46]

The rearrangement unit 46 inputs, to the generative AI, information including instruction information (an example of second instruction information) including information indicating an instruction to rearrange the plurality of news articles selected by the selection unit 45 and information indicating a restriction condition of the rearrangement and the plurality of news articles selected by the selection unit 45 as a prompt that is input information, and outputs rearrangement information of the plurality of news articles selected by the selection unit 45 from the generative AI.

The instruction information includes, for example, information of a character string “Rearrange the plurality of news articles provided in accordance with the following rearrangement criteria” and information indicating the rearrangement criteria as the information indicating the restriction condition of the rearrangement. The information indicating the rearrangement criteria is, for example, information of a character string “Rearrangement Criteria \n\n Arrange the news articles in order of importance along the following editing policy. \n \n The editing policy is based on the following elements, and consider the following additional criteria: \n Speediness, Public Benefit, Reliability, Novelty, Interest, Degree of Recognition\n \n Additional Criteria \n Prioritize news articles in Japan\n Familiar News Priority Articles \n News articles distributed in the past several hours”, but is not limited to such an example.

The prompt includes, in addition to the above-described instruction information, information of an input format and information of an output format. The information of the input format is information of a format of the news article group, for example, information indicated in a JSON format, and is information indicating a format for listing combinations of titles, body snippets, and categories of the news articles included in the news article group, but is not limited to such an example.

The information of the output format is information of a format of the information to be output by the generative AI. The information of the output format is, for example, information indicated in a JSON format, and is information indicating a format for listing m combinations of titles of the news articles and summaries of the news articles as one set, but is not limited to such an example. m is an integer of 1 or more.

The rearrangement unit 46 causes the generative AI to output the summaries of the news articles, and can improve rearrangement accuracy as compared with a case where the news articles are rearranged without outputting the summaries. Note that the rearrangement unit 46 can also improve rearrangement accuracy, for example, by further including information indicating an instruction to output a reason for the rearrangement in the instruction information.

### [3.3.5. Summarization Unit 34]

The summarization unit 34 causes the generative AI to execute summarization of each of the plurality of news articles selected and rearranged by the selection and rearrangement unit 33.

The summarization unit 34 is, for example, processing of causing the generative AI to execute summarization of each of the plurality of news articles by the selection and rearrangement unit 33 using a prompt including instruction information (an example of third instruction information) including information indicating an instruction to summarize each of the plurality of news articles rearranged by the selection and rearrangement unit 33 and information of the plurality of news articles rearranged by the selection and rearrangement unit 33.

The summary of each of the plurality of news articles rearranged by the selection and rearrangement unit 33 is, for example, a summary of the title and the body snippet of each of the plurality of news articles rearranged by the selection and rearrangement unit 33, but is not limited to such an example.

The instruction information includes, for example, information of a character string “Summarize a title and a body of each of the plurality of news articles provided”. Further, the instruction information includes information of a character string “Please summarize a title and a body of each of the plurality of news articles provided, with reference to the following input/output example” and information indicating the input/output example. The information indicating the input/output example is information using the title and the body snippet of the news article as an input example and the summarized title and body snippet as an output example, and includes information of a plurality of input/output examples.

Further, the instruction information may include information defining the number of characters of the summary of the title and information defining the number of characters of the summary of the body snippet. For example, the instruction information includes information of a character string “The summary of the title of the news article should be about 15 characters, and the summary of the body of the news article should be about 30 characters”, but is not limited to such an example.

The prompt includes, in addition to the above-described instruction information, information of an input format and information of an output format. The information of the input format is information of a format of the news article group, for example, information indicated in a JSON format, and is information indicating a format for listing combinations of titles, body snippets, and categories of the news articles included in the news article group, but is not limited to such an example.

For example, the information of the input format may include information of the body of the news article instead of the information of the body snippet of the news article. In this case, the information of the news article included in the prompt includes information of the body of the news article instead of the information of the body snippet of the news article.

The information of the output format is information of a format of the information to be output by the generative AI. The information of the output format is, for example, information indicated in a JSON format, and is, for example, information indicating a format for listing combinations of titles and body snippets of the summarized news articles, but is not limited to such an example.

Note that, in the example described above, the selection and rearrangement unit 33 separately executes selection processing of selecting the plurality of news articles from the news article group and rearrangement processing of rearranging the plurality of news articles, but the selection processing and the rearrangement processing may be performed at a time.

For example, the selection and rearrangement unit 33 can also cause the generative AI to execute selection and rearrangement of the plurality of news articles using a prompt including information including instruction information (an example of first instruction information) including information indicating an instruction to select the plurality of news articles from the news article group and information indicating the restriction condition of the selection and instruction information (an example of second instruction information) including information indicating an instruction to rearrange the plurality of news articles and information indicating the restriction condition of the rearrangement, and information of the news article group.

### [3.3.6. Distribution Unit 35]

The distribution unit 35 distributes various types of information. The distribution unit 35 distributes various types of information by transmitting various types of information to the terminal apparatus 2 via the communication unit 10 and the network N.

For example, the distribution unit 35 distributes the plurality of news articles summarized by the summarization unit 34. For example, the distribution unit 35 distributes the plurality of news articles summarized by the summarization unit 34 by transmitting the plurality of news articles summarized by the summarization unit 34 to the terminal apparatus 2 via the communication unit 10 and the network N.

In a case where a distribution request is received from a dedicated application installed in the terminal apparatus 2, the distribution unit 35 transmits the plurality of news articles summarized by the summarization unit 34 to the terminal apparatus 2. The terminal apparatus 2 receives a plurality of news articles transmitted from the information processing apparatus 1, and displays the received plurality of news articles.

FIG. 7 is a view illustrating an example of an application screen distributed by the distribution unit 35 in the processing unit 12 of the information processing apparatus 1 according to the embodiment and displayed on the terminal apparatus 2. The application screen 60 illustrated in FIG. 7 is a screen displayed by the dedicated application, and includes a search box 61, a search button 62, a tab column 63, and tab content 64, 70.

A search keyword is input to the search box 61 by a user U operating the terminal apparatus 2. When the search button 62 is selected by the user U operating the terminal apparatus 2 in a state where the search keyword is input to the search box 61, the terminal apparatus 2 transmits a search query including the search keyword input to the search box 61 to the information processing apparatus 1. The distribution unit 35 transmits a search result corresponding to the search keyword included in the search query to the terminal apparatus 2. Such a search result is displayed by the terminal apparatus 2.

The tab column 63 includes a plurality of tabs 63a, 63b, 63c, 63d, 63e selectable by the user U. The tab 63a is a tab “all”, the tab 63b is a tab “news”, the tab 63c is a tab “sports”, the tab 63e is a tab “topic”, and the tab 63e is a tab “IT”. In the example illustrated in FIG. 7, the tab “news” is selected and highlighted.

In the tab content 64, 70, a plurality of kinds of content corresponding to the tab selected in the tab column 63 is arranged. In the example illustrated in FIG. 7, the tab content 64 includes a title 65, summary information 66a, 66b, 66c, description information 67, and a next button 68. The title 65 includes information of a character string “AI digest updated at 13 o′clock”, and indicates that the summary information 66a, 66b, and 66c is a summary by AI and has been updated at 13 o'clock.

Respective pieces of the summary information 66a, 66b, and 66c include summaries of titles and summaries of the body snippets of the news articles that are information of the news articles summarized by the summarization unit 34 and are different from each other. Furthermore, each of the summary information 66a, 66b, and 66c includes link information to a corresponding news article, and the user U selects any one of the summary information 66a, 66b, and 66c to display the news article corresponding to the selected summary information on the terminal apparatus 2.

The description information 67 includes information for explaining a creator of the summary information, and in the example illustrated in FIG. 7, information of a character string “This function uses AI, and accuracy is not guaranteed.” is included. As a result, the user U can easily grasp that the summary information 66a, 66b, and 66c is generated by AI.

The next button 68 is a graphical user interface (GUI) button for displaying, on the terminal apparatus 2, news articles other than the news articles displayed on the terminal apparatus 2 among the plurality of news articles summarized by the summarization unit 34. In the example illustrated in FIG. 7, the first three news articles among the plurality of news articles summarized by the summarization unit 34 are displayed on the terminal apparatus 2. By selecting the next button 68, the user U displays three news articles in the next rank on the terminal apparatus 2.

The tab content 70 includes article content 71a, 71b. Each of the article content 71a, 71b includes a title and a body snippet of the news article. Each of the article content 71a, 71b includes link information to a corresponding news article, and the user U selects one of the article content 71a, 71b to display the news article corresponding to the selected article content on the terminal apparatus 2.

The article content included in the tab content 70 includes titles and body snippets of the news articles included in the news article group, and includes titles and body snippets of news articles which are not summarized by the summarization unit 34 among the news articles included in the news article group. Furthermore, the article content included in the tab content 70 includes the titles and the body snippets of the news articles summarized by the summarization unit 34, but does not have to include the titles and the body snippets of the news article summarized by the summarization unit 34.

### [4. Processing Procedure]

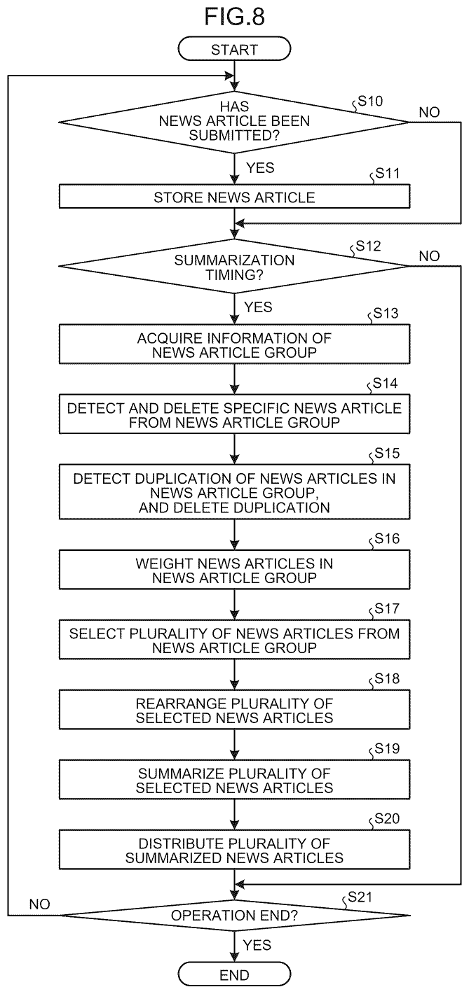

Next, procedure of information processing by the processing unit 12 of the information processing apparatus 1 according to the embodiment will be described. FIG. 8 is a flowchart indicating an example of the information processing by the processing unit 12 of the information processing apparatus 1 according to the embodiment.

As indicated in FIG. 8, the processing unit 12 of the information processing apparatus 1 determines whether or not a news article has been submitted (Step S10). In a case where the processing unit 12 determines that a news article has been submitted (Step S10: Yes), the processing unit 12 stores information of the submitted news article in the storage unit 11 (Step S11).

In a case where the processing in Step S11 ends or in a case where it is determined that a news article has not been submitted (Step S10: No), the processing unit 12 determines whether or not a summarization timing has come (Step S12). The summarization timing is a timing that comes at a predetermined cycle or a timing designated by an operator of the information processing apparatus 1, but is not limited to such an example.

In a case where it is determined that the summarization timing has come (Step S12: Yes), the processing unit 12 acquires information of the news article group including a plurality of news articles up to a time before a predetermined period from the storage unit 11, or the like (Step S13). Then, the processing unit 12 detects and deletes a specific news article from the news article group for which information is acquired in Step S13 (Step S14).

Subsequently, the processing unit 12 detects duplication of news articles in the news article group, and deletes news articles other than one of the detected news articles, thereby deleting the duplication of the news articles (Step S15). Then, the processing unit 12 weights the news articles in the news article group (Step S16).

Subsequently, the processing unit 12 selects a plurality of news articles from the news article group (Step S17), and rearranges the plurality of selected news articles (Step S18). Thereafter, the processing unit 12 summarizes the plurality of selected news articles (Step S19) and distributes the plurality of summarized news articles (Step S20).

In a case where the processing in Step S20 ends or in a case where it is determined that the summarization timing has not come (Step S12: No), the processing unit 12 determines whether or not an operation end timing has come (Step S21). For example, in a case where the information processing apparatus 1 is powered off, the processing unit 12 determines that the operation end timing has come.

In a case where it is determined that the operation end timing has not come (Step S21: No), the processing shifts to the processing to Step S10, and in a case where it is determined that the operation end timing has come (Step S21: Yes), the processing unit 12 ends the processing indicated in FIG. 8.

### [5. Modifications]

In the example described above, in the summarization unit 34, the information of the plurality of news articles selected and rearranged by the selection and rearrangement unit 33 is collectively included in the input information and input to the generative AI, but the present invention is not limited to such an example. For example, the summarization unit 34 can cause the generative AI to individually summarize the plurality of news articles selected and rearranged by individually including information of the plurality of news articles selected and rearranged by the selection and rearrangement unit 33 in the input information. As a result, for example, as compared with a case where a plurality of news articles selected by the selection and rearrangement unit 33 are collectively summarized, the summarization unit 34 can avoid confusion of information among the plurality of news articles, thereby increasing a possibility of improving summarization accuracy, and generating summaries of a plurality of news in more optimal arrangement without including erroneous information.

Furthermore, the summarization unit 34 can also cause the generative AI to summarize each of p news articles for each of the p news articles by dividing the information of the plurality of news articles selected and rearranged by the selection and rearrangement unit 33 into information of the p news articles (p is an integer of 2 or more) and including the information of the p news articles in the input information for each of the divided information of the p news articles. This also enables the summarization unit 34 to avoid confusion of information among the plurality of news articles, for example, as compared with a case where the plurality of news articles selected by the selection and rearrangement unit 33 are summarized collectively. This can increase a possibility of improving summarization accuracy and can generate summaries of the plurality of news in more optimal arrangement without including erroneous information.

The deletion target detection processing and the weighting processing in the preprocessing unit 32 can also be performed using instruction information corresponding to information of an attribute (for example, a combination of gender and age) of the user U to whom the summary of the news article is to be provided. In addition, the selection processing and the rearrangement processing in the selection and rearrangement unit 33 can be performed using instruction information corresponding to information of the attribute (for example, a combination of gender and age) of the user U to whom the summary of the news article is to be provided.

Furthermore, the summarization processing in the summarization unit 34 can be performed using instruction information corresponding to information of the attribute (for example, a combination of gender and age) of the user U to whom the summary of the news article is to be provided. For example, the summarization unit 34 can summarize news articles using instruction information including information designating the number of summaries and a summarization method according to the attribute of the user U to whom the summary of the news articles is to be provided.

Furthermore, in the selection processing in the selection and rearrangement unit 33, a news article can be selected using instruction information including information indicating an instruction to preferentially select a news article including a trend word acquired from an external apparatus.

Furthermore, in the rearrangement processing in the selection and rearrangement unit 33, a news article can be selected using instruction information including information indicating an instruction to give priority to a news article including a trend word acquired from an external apparatus.

Furthermore, the processing unit 12 can also process the summary of the news articles based on the information of the news article group in real time. For example, the processing unit 12 can also process the summary of the news article based on the information of the news article group in real time using the instruction information based on context of the user U to whom the summary of the news article is to be provided. The processing unit 12 can perform processing using instruction information based on the context of the user U as one or more pieces of instruction information of the deletion target detection processing, the weighting processing, the selection processing, the rearrangement processing, and the summarization processing.

The generative AI may be multi-modal generative AI including a function of the text generative AI, or the like. The multi-modal generative AI is, for example, generative AI capable of generating a text or an image from a text, an image, or the like. The multi-modal generative AI is, for example, GPT-4 Turbo with vision, gemini, chameleon multimodal model (CM3Leon), or the like, but is not limited to such an example.

The information processing apparatus 1 uses the same generative AI in the duplication detection processing, the first detection processing, the second detection processing, the weighting processing, the selection processing, the rearrangement processing, and the summarization processing, but some or all of these kinds of processing may use different generative AI.

Furthermore, in the above-described example, the information of the news article group input to the generative AI is not the body of the news article but the body snippet of the news article, but is not limited to such an example, and the information of the news article group input to the generative AI may include the body of the news article instead of the body snippet of the news article, and may further include the image of the news article.

### [6. Hardware Configuration]

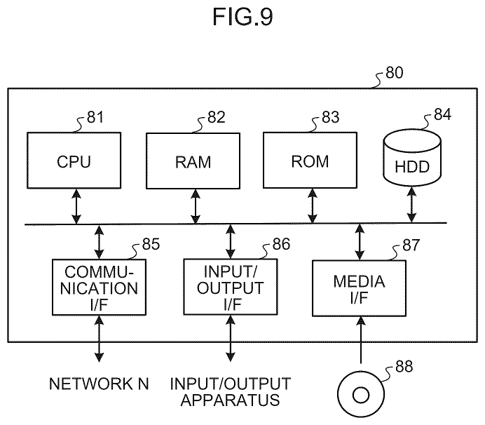

The information processing apparatus 1 according to the above-described embodiment is implemented by a computer 80 having a configuration as illustrated in FIG. 9, for example. FIG. 9 is a hardware configuration diagram illustrating an example of the computer 80 that implements functions of the information processing apparatus 1 according to the embodiment. The computer 80 includes a CPU 81, a RAM 82, a read only memory (ROM) 83, a hard disk drive (HDD) 84, a communication interface (I/F) 85, an input/output interface (I/F) 86, and a media interface (I/F) 87.

The CPU 81 operates based on a program stored in the ROM 83 or the HDD 84, and controls each unit. The ROM 83 stores a boot program to be executed by the CPU 81 when the computer 80 is started, a program depending on hardware of the computer 80, and the like.

The HDD 84 stores a program to be executed by the CPU 81, data to be used by the program, and the like. The communication interface 85 receives data from other devices via the network N (see FIG. 2), transmits the data to the CPU 81, and transmits data generated by the CPU 81 to other devices via the network N.

The CPU 81 controls an output apparatus such as a display and a printer, and an input apparatus such as a keyboard and a mouse via the input/output interface 86. The CPU 81 acquires data from the input apparatus via the input/output interface 86. In addition, the CPU 81 outputs the generated data to the output apparatus via the input/output interface 86.

The media interface 87 reads a program or data stored in a recording medium 88 and provides the program or data to the CPU 81 via the RAM 82. The CPU 81 loads the program from the recording medium 88 on the RAM 82 via the media interface 87, and executes the loaded program. The recording medium 88 is, for example, an optical recording medium such as a digital versatile disc (DVD) or a phase change rewritable disk (PD), a magneto-optical recording medium such as a magneto-optical disk (MO), a tape medium, a magnetic recording medium, a semiconductor memory, or the like.

For example, in a case where the computer 80 functions as the information processing apparatus 1 according to the embodiment, the CPU 81 of the computer 80 implements the function of the processing unit 12 by executing the program loaded on the RAM 82. In addition, the HDD 84 stores data in the storage unit 11. The CPU 81 of the computer 80 reads and executes these programs from the recording medium 88, but as another example, may acquire these programs from another apparatus via the network N.

### [7. Others]

Among the respective kinds of processing described in the above embodiment, all or part of the processing described as being automatically performed can be manually performed, or all or part of the processing described as being manually performed can be automatically performed by a known method. In addition, the processing procedure, specific name, and information including various kinds of data and parameters indicated in the document and the drawings can be arbitrarily changed unless otherwise specified. For example, various kinds of information indicated in each drawing are not limited to the indicated information.

In addition, the respective components of the respective apparatuses illustrated in the drawings are functionally conceptual, and are not necessarily physically configured as illustrated in the drawings. In other words, a specific form of distribution and integration of the respective apparatuses is not limited to the illustrated form, and all or part thereof can be functionally or physically distributed and integrated in an arbitrary unit according to various kinds of load, usage conditions, and the like.

For example, the above-described information processing apparatus 1 may be implemented by a terminal apparatus and a server computer, may be implemented by a plurality of server computers, or may be implemented by calling an external platform, or the like, with an API, network computing, or the like, depending on functions, so that the configuration can be flexibly changed.

In addition, the above-described embodiment and modifications can be appropriately combined within a range that does not contradict processing content.

### [8. Effects]

As described above, the information processing apparatus 1 according to the embodiment includes: the selection and rearrangement unit 33 that causes generative AI to execute selection and rearrangement of a plurality of news articles using instruction information (an example of the first instruction information) including information indicating an instruction to select the plurality of news articles and information indicating a restriction condition of the selection and instruction information (an example of the second instruction information) including information indicating an instruction to rearrange the plurality of news articles and information indicating a restriction condition of the rearrangement; and the summarization unit 34 that causes the generative AI to execute summarization of each of the plurality of news articles using instruction information (an example of the third instruction information) including information indicating an instruction to summarize each of the plurality of news articles selected and rearranged by the selection and rearrangement unit 33. As a result, the information processing apparatus 1 can appropriately narrow down the news articles to be summarized as compared with a case where all the news articles in the news article group to be distributed are summarized, and can effectively summarize the news articles. Furthermore, the information processing apparatus 1 rearranges the news articles before summarization, so that the information processing apparatus 1 can appropriately summarize the news articles.

Furthermore, the selection and rearrangement unit 33 rearranges the plurality of news articles using the generative AI after selecting the plurality of news articles using the generative AI. This enables the information processing apparatus 1 to appropriately summarize news articles.

Furthermore, the information processing apparatus 1 includes the preprocessing unit 32 that performs, using the generative AI, preprocessing on a news article group from which the plurality of news articles is to be selected by the selection and rearrangement unit 33. This enables the information processing apparatus 1 to appropriately select news articles.

In addition, the preprocessing unit 32 includes the duplication detection unit 40 that performs, using the generative AI, processing of detecting duplication of news articles with use of instruction information including an instruction to detect duplication of the news articles in the news article group. This enables the information processing apparatus 1 to appropriately select news articles.

Furthermore, the preprocessing unit 32 includes the deletion target detection unit 41 that performs, using the generative AI, processing of detecting a specific news article with use of instruction information including an instruction to detect the specific news article that is a deletion target in the news article group. This enables the information processing apparatus 1 to appropriately select news articles.

In addition, the preprocessing unit 32 includes the weighting unit 42 that performs, using the generative AI, processing of weighting news articles with use of instruction information including an instruction to weight the news articles in the news article group. This enables the information processing apparatus 1 to appropriately select news articles.

Furthermore, the weighting unit 42 causes the generative AI to output weights of the news articles in the news article group, and then rearranges the news articles in the news article group based on the weights. This enables the information processing apparatus 1 to appropriately select news articles.

Although the embodiment of the present application has been described in detail with reference to the drawings, this is merely an example, and the present invention can be implemented in other forms to which various modifications and improvements have been made based on the knowledge of those skilled in the art, including the aspects described in the disclosure of the invention.

In addition, the “unit (section, module, unit)” described above can be read as “means”, “circuit”, or the like. For example, the acquisition unit can read as acquisition means or an acquisition circuit.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An information processing apparatus comprising:
a selection and rearrangement unit that causes generative AI to execute selection and rearrangement of a plurality of news articles using first instruction information including information indicating an instruction to select the plurality of news articles and information indicating a restriction condition of the selection and second instruction information including information indicating an instruction to rearrange the plurality of news articles and information indicating a restriction condition of the rearrangement; and
a summarization unit that causes the generative AI to execute summarization of each of the plurality of news articles using third instruction information including information indicating an instruction to summarize each of the plurality of news articles selected and rearranged by the selection and rearrangement unit.

2. The information processing apparatus according to claim 1, wherein
the selection and rearrangement unit
rearranges the plurality of news articles using the generative AI after selecting the plurality of news articles using the generative AI.

3. The information processing apparatus according to claim 1, comprising
a preprocessing unit that performs, using the generative AI, preprocessing on a news article group from which the plurality of news articles is to be selected by the selection and rearrangement unit.

4. The information processing apparatus according to claim 3, wherein
the preprocessing unit
comprises a duplication detection unit that performs, using the generative AI, processing of detecting duplication of news articles with use of instruction information including an instruction to detect duplication of the news articles in the news article group.

5. The information processing apparatus according to claim 3, wherein
the preprocessing unit
comprises a deletion target detection unit that performs, using the generative AI, processing of detecting a specific news article with use of instruction information including an instruction to detect the specific news article that is a deletion target in the news article group.

6. The information processing apparatus according to claim 3, wherein
the preprocessing unit
comprises a weighting unit that performs, using the generative AI, processing of weighting news articles with use of instruction information including an instruction to weight the news articles in the news article group.

7. The information processing apparatus according to claim 3, wherein
the preprocessing unit comprises:
a duplication detection unit that performs, using the generative AI, processing of detecting duplication of news articles with use of instruction information including an instruction to detect duplication of the news articles in the news article group;
a deletion target detection unit that performs, using the generative AI, processing of detecting a specific news article with use of instruction information including an instruction to detect the specific news article that is a deletion target in the news article group; and
a weighting unit that performs, using the generative AI, processing of weighting news articles with use of instruction information including an instruction to weight the news articles in the news article group.

8. The information processing apparatus according to claim 7, wherein
the weighting unit
causes the generative AI to output weights of the news articles in the news article group, and then rearranges the news articles in the news article group based on the weights.

9. An information processing method to be executed by a computer, the method comprising:
causing generative AI to execute selection and rearrangement of a plurality of news articles using first instruction information including information indicating an instruction to select the plurality of news articles and information indicating a restriction condition of the selection and second instruction information including information indicating an instruction to rearrange the plurality of news articles and information indicating a restriction condition of the rearrangement; and
causing the generative AI to execute summarization of each of the plurality of news articles using third instruction information including information indicating an instruction to summarize each of the plurality of the selected and rearranged news articles.

10. A non-transitory computer readable storage medium storing information processing program causing a computer to execute:
causing generative AI to execute selection and rearrangement of a plurality of news articles using first instruction information including information indicating an instruction to select the plurality of news articles and information indicating a restriction condition of the selection and second instruction information including information indicating an instruction to rearrange the plurality of news articles and information indicating a restriction condition of the rearrangement; and
causing the generative AI to execute summarization of each of the plurality of news articles using third instruction information including information indicating an instruction to summarize each of the plurality of the selected and rearranged news articles.
